(19) United States
(12) Patent Application Publication
(10) Pub. No.: US 2014/0016649 A1
(43) Pub. Date: Jan. 16, 2014

(54) OPTIMIZING FORWARD DATABASE FOR A BURSTY NETWORK TRAFFIC

(71) Applicant: Puneet Sinha, Bangalore (IN)

(72) Inventor: Puneet Sinha, Bangalore (IN)

(73) Assignee: TEJAS NETWORKS LIMITED, Bangalore (IN)

(21) Appl. No.: 14/008,077

(22) PCT Filed: Aug. 11, 2011
(86) PCT No.: PCT/IN2011/000542

§ 371 Date: Sep. 27, 2013

(30) Foreign Application Priority Data
Mar. 31, 2011 (IN) 1100/CHE/2011

(51) Int. Cl. H04L 12/741

(52) U.S. Cl. CPC H04L 45/745
USPC 370/401

(57) ABSTRACT

The present invention discloses a method for optimizing forwarding database (FDB Table) in a bursty traffic computer network environment. In one embodiment herein there is provided a small lookup table that is created by manually filling static entries of nodes, and by filling dynamic entries that are automatically made by the switch while learning and forwarding process. A MAC address is looked in the small lookup table first, and upon finding the said address, the same is used for forwarding a packet. The MAC address may be copied from the FDB Table into the small lookup table upon not finding the said address into the small lookup table.

### FIELD OF THE INVENTION

The present invention relates to protection switching and more particularly to restoration mechanism in a communication network.

### BACKGROUND

In a typical computer network, the network peers send and receive data packets. Each packet of data follows a particular path from source peer to the destination peer. Generally, the network peers or nodes are connected using tree type topology or Ring topology.

In tree topology, path of a data packet is in the form of a tree wherein lots of network nodes are connected to each other. The data packets are sent from source to destination in a single unique path using a particular tree formation protocol.

Different tree formation protocols are known in the art including spanning tree protocol (STP), Rapid STP (RSTP), Multiple STP (MSTP) etc. The SIP protocol is a Data Link Layer protocol defined in IEEE 802.1D. It creates a spanning tree within a mesh network of connected layer-2 bridges (typically Ethernet switches), and disables those links that are not part of the spanning tree, thereby leaving a single active path between any two network nodes.

A switch learns the source MAC address specified in the header of a data packet it receives by creating an entry in the FDB, the entry including the source MAC address and the port number of the port via which the packet is received. The switch also looks up in the FDB the destination MAC address specified in the header of the data packet, and forwards the packet to the appropriate switch port specified in the FDB if a matching entry is found. If no match is found then the packet is flooded to all ports on the switch in an attempt to ensure the packet reaches its destination.

As the number of the network equipment increases, the size of FOB in a network switch also increases. And with every packet of data, the switch has to look twice in the FDB for source and destination address. Therefore, for one mil/ion packets of data being received in a second (for example), the switch has to look two million times in the FDB table. So the average time available to search a MAC address in the FDB becomes low, and beyond a limit, cost of maintaining such a large number of MAC addresses in the FDB while providing the real time switching, becomes very high. Hence for huge networks, increasing the capacity of switch will increase the cost also.

In most of the cases like in offices, the networks are of Server-Client type. A good part of the traffic in such networks is towards or from a few network elements e.g. Gateways or Internet Servers. Furthermore, the data traffic is generally bursty in nature.

Therefore, there is required a novel solution for optimizing the FOB being maintained in a switch.

### SUMMARY

An object of this invention is to reduce the average time taken for learning the MAC address by the switch.

Another object of the present invention is to reduce the lookup time of the MAC address of the destination for a bursty traffic where multiple packets are received in a burst from a source to a destination.

In accordance with this there is provided a solution for optimizing forwarding database (FDB Table) in a bursty traffic computer network environment.

In one embodiment herein a small but fast primary FDB may be created. The large FDB, which can be slower to save cost, is here after termed as secondary FDB.

The primary FDB includes two types of entries. One of these is created by the operator by manually provisioning MAC addresses of nodes which are expected to send and receive large part of the total traffic. The entries of port and time for these MAC addresses will be learned by the switch while learning process. These entries remain in primary FDB until the operator un-provision them.

Second type of entries consists of MAC addresses which are filled by the switch based on the following algorithm:

The source MAC address of the received packet is first searched in primary FDB. If the entry is found the value of port and time is updated. If it is not found in primary FDB, a new entry for this MAC address is created in the primary FOB and port and time values are updated accordingly.

The destination MAC address of the received packet is first searched in the primary FDB and upon finding the said address in primary FDB, the said packet is forwarded based on the information fetched from primary FDB.

Also a MAC address may be copied from the secondary FDB Table into the small lookup table upon not finding the said address into the primary FOB.

As the size of primary FDB is substantially less than that of secondary FOB, on reaching a condition where there is no space in primary FDB for creating a new entry, one of the said second type of entries in the primary FDB may be moved to secondary FDB.

In one embodiment herein, the primary FDB is filled with substantially small number of entries with respect to the number of entries maintained with the secondary FDB.

In one embodiment herein, the primary FDB may be embedded within the network processor.

In one embodiment herein, the primary FDB may be created on cache memory or enabling supported hardware.

Other objects, features and advantages of the invention will be apparent from the drawings, and from the detailed description that follows below.

### BRIEF DESCRIPTION OF THE DRAWINGS

Reference will be made to embodiments of the invention, examples of which may be illustrated in the accompanying figures.

FIG. 1 illustrates algorithm of optimizing forwarding database (FDB Table) in a bursty traffic computer network environment according to the present invention.

FIG. 2 shows structure of the small lookup table and the FDB table according to the present invention.

### DESCRIPTION OF THE INVENTION

The present invention described herein, teaches a method for forwarding database (FDB Table) look up in a bursty traffic computer network environment. In one embodiment herein there is provided a primary FOB which is created by filling static and dynamic MAC address entries of servers and nodes into the table, or by copying the MAC address from the secondary FDB. The primary FDB is first looked up for the MAC address and upon finding the said address, a packet is forwarded.

In the following description, for purpose of explanation, specific details are set forth in order to provide an understanding of the invention. It will be apparent, however, to one skilled in the art that the invention may be practiced without these details. One skilled in the art will recognize that embodiments of the present invention, some of which are described below, may be incorporated into a number of different systems. The best mode of the invention described in the specification illustrates the exemplary embodiment of the invention. It is understood that one skilled in art may modify or change the modules used in the best mode of invention.

Reference in the specification to “one embodiment” or “an embodiment” means that a particular feature, characteristic, or function described in connection with the embodiment is included in at least one embodiment of the invention. The appearances of the phrase “in one embodiment” in various places in the specification are not necessarily all referring to the same embodiment.

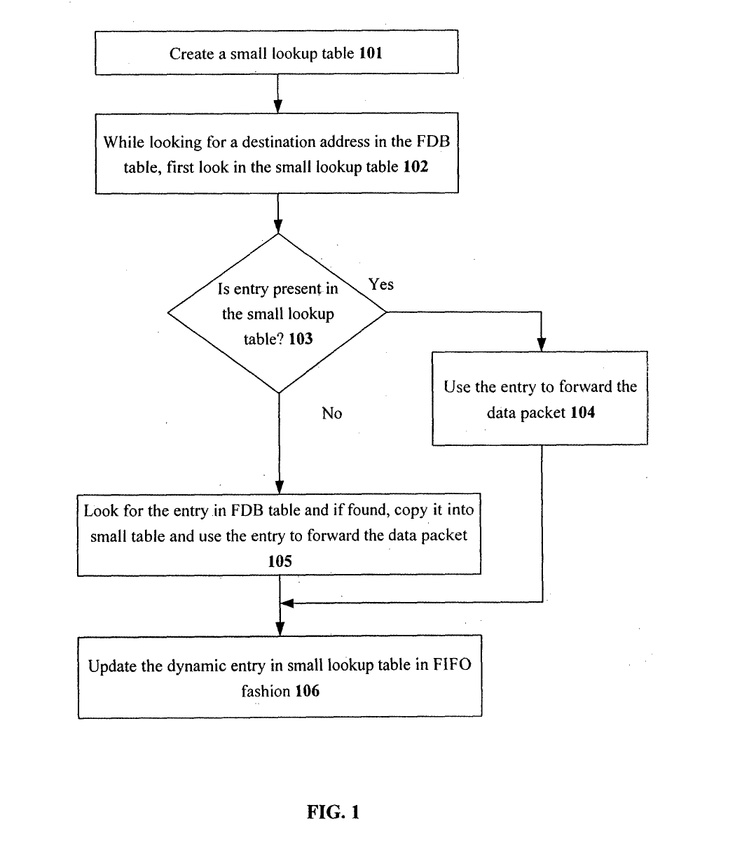

FIG. 1 illustrates algorithm of optimizing forwarding database (FDB Table) look up in a bursty traffic computer network environment according to the present invention. In step 101, a primary FDB is created. The purpose of this primary FOB is to enable a network administrator to make manual entries of MAC addresses of nodes which are expected to send and receive large part of the traffic, in the faster primary FDB and not in slower secondary FDB to reduce the average look up time. This primary FDB has less number of entries as compared to the secondary FDB of the switch. Also the primary FDB is faster than the secondary FDB.

In step 102, while looking in the FDB for a destination address, a MAC address is first searched in the primary FDB, and upon finding the said address, a packet is forwarded towards the destination. The small lookup table also contain dynamic entries (MAC addresses) that are automatically made by the switch while learning and forwarding process.

Apart from the static and dynamic MAC addresses, the entries in the small table include dynamic entries that are Port and Time.

Since the small table has lesser number of entries, and it is faster than the FDB, the average time to look up in the FDB table reduces and capacity of the switch to forward data packets increases without any increase in the cost of the switch.

In step 103, entry for the MAC address being searched in the small table is checked. In step 104 if the entry is found, the packet is forwarded towards the destination address.

In step 105 a MAC address may be copied from the FDB Table into the small lookup table upon not finding the said address into the small lookup table. Finally in step 106, all the dynamic entries are updated in the small lookup table updated in cyclic FIFO fashion. For example, if the last entry in the small lookup table was made at 4th position, the next entry has to be made at 5th position.

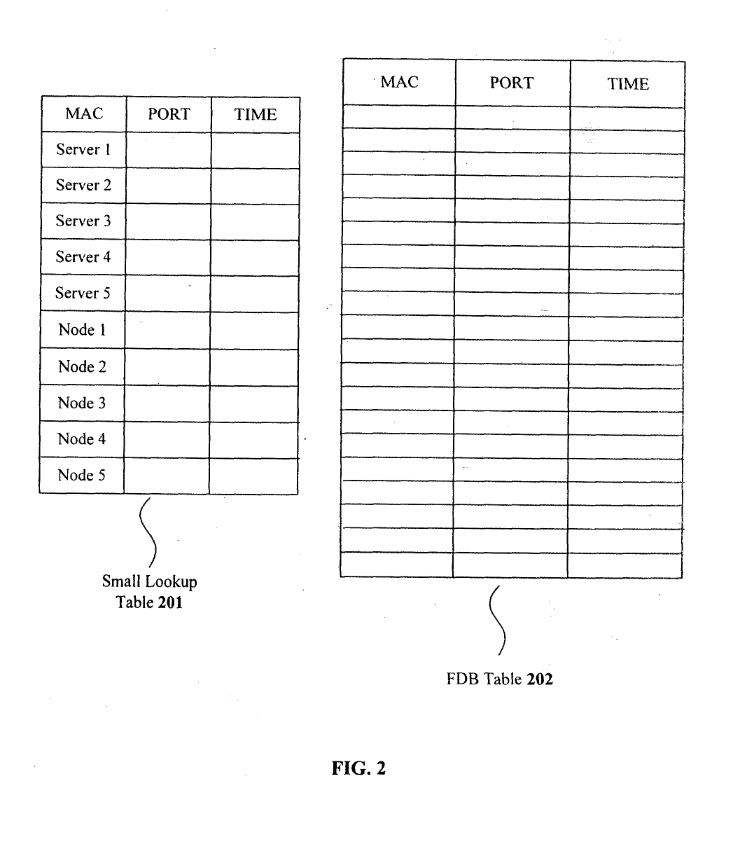

FIG. 2 shows structure of the small lookup table and the FDB table according to the present invention.

In one embodiment herein, the lookup table is filled with substantially small number of entries with respect to the number of entries maintained with the FOB Table. The small lookup table may be embedded within the network processor.

Also the small lookup table is faster than the FDB. The small lookup table contains static MAC addresses that are manually made and dynamic entries (MAC addresses) that are automatically made by the switch while learning and forwarding process. Also, the lookup table has dynamic entries including Port and Time at which the packet is being received for a particular MAC address.

The above disclosed embodiments of the present invention are quite useful in bursty traffic within a network. In a bursty traffic multiple packets will be received from a source to a destination and for all those packets, the destination will be found small table.

Further, as the MAC addresses for the servers are always present in the small table, the average search time would be less.

The foregoing description of the invention has been described for purposes of clarity and understanding. It is not intended to limit the invention to the precise form disclosed. Various modifications may be possible within the scope and equivalence of the appended claims.

1. A method for optimizing forwarding database (FDB) lookup of a switch in a communication network, the method comprising:
instantiating a primary FDB;
instantiating a secondary FDB;
receiving at least one packet from at least one port of the switch;
performing look up operation for destination MAC address of the said packet on primary FDB;
performing look up operation for destination MAC address of the said packet on secondary FDB; and
copying to update, the said destination MAC address from the secondary FDB into the primary FDB, in cyclic FIFO fashion.

2. (canceled)

3. The method of claim 1, further comprising
moving the entries from primary FDB to secondary FDB;
performing look up for source MAC address of the said received packet in primary FDB;
updating the entry for the said source MAC address in primary FDB upon finding it in primary FDB; and
creating a new entry for source MAC in the primary FDB upon not finding it in primary FDB.

4. The method of claim 1, wherein the primary FDB includes static entries of MAC address provisioned by operator to remain in primary FDB unless up-provisioned by the operator.

5. The method of claim 1, wherein the primary FDB is embedded within network processor, and wherein the primary FDB is created in cache memory of the processor or by enabling supported hardware with fast access time from the processor.

6. The method of claim 1, wherein the secondary FDB is instantiated in a RAM.

7. The method of claim 1, wherein the primary FDB has faster access time to access the entries than the secondary FDB.

8. The method of claim 1, wherein the operation of look up for destination MAC address of the said packet on secondary FDB is performed if the said destination address is not found in the primary FDB.

9. The method of claim 1, wherein copying the said destination MAC address from the secondary FDB into the primary FDB is performed when lookup in primary FDB fails and the said address is found in the secondary FDB.

10. The method of claim 3, wherein moving the entries from primary FDB to secondary FDB is performed if there is no space in primary FDB for a new entry.

11. The method of claim 1, wherein the entries pertaining to a MAC address in the FDB include the MAC address, port, VLAN, time, etc.

12. (canceled)
